(19) United States
(12) Patent Application Publication
(10) Pub. No.: US 2006/0162789 A1
(43) Pub. Date: Jul. 27, 2006

(54) Multiple inlet stream fluid cartridge

(76) Inventor: David Di Nunzio, Mentor, OH (US)

Correspondence Address: David Di Nunzio, 9314 Lake Shore, Mentor, OH, 44060, US

(21) Appl. No.: 11/338,509

(22) Filed: Jan. 24, 2006

Related U.S. Application Data
(60) Provisional application No. 60/646,344, filed on Jan. 24, 2005.

(51) Int. Cl. F16K 11/078

(52) U.S. Cl. 137/625.4

(57) ABSTRACT

A control disk insert for a one lever mixer valve (20) contains two preferably, planar disks, whereof one fixed control disk (24) has at least one opening zone for hot water and at least one opening zone for cold water. The movable control disk (22) facing the fixed control disk (24) and movable with two degrees of freedom can both completely close and continuously completely open the opening zones in the fixed control disk (24). The opening zones of the fixed control disk (24) and the closed control zones, i.e. openings (64, 68) of the movable control disk are constructed in such a way that the control disk (22) insert has two completely separated, independently operating but mechanically coupled control systems. Both control systems can be used for a common water outlet (74), or for two separate water outlets. The fixed control disk (24) splits one or both inlet streams so that more intersecting flow area is possible at the control surface when compared to other current single handle mixing cartridges that do not let flow exit at the boundary of a movable disk control surface in communication with a fixed disk control surface.

### CROSS-REFERENCE TO RELATED APPLICATIONS

This application claims the benefit of provisional patent application Ser. No. 60/646,344 filed Jan. 24, 2005 by the present inventor.

### FEDERALLY SPONSORED RESEARCH

Not Applicable

### SEQUENCE LISTING OR PROGRAM

Not Applicable

### BACKGROUND OF THE INVENTION

1. Field of the Invention

This invention relates to faucets which control the mixing of hot and cold water. More particularly, the invention relates to faucets of the foregoing type wherein a movable disk is both rotated and directed in a linear manner over a stationary disk by an operating spindle.

2. Prior Art

There are problems with certain mixing valves which utilize movable and stationary disks (e.g. ceramic disks). Prior art arrangements of faucets and mixing valves (e.g. cartridges) appear to suffer from common disadvantages such as (a) they restrict area of inlet water to a mixing chambers. (b) they require additional space for larger cartridges if more area is needed. (c) they require larger exterior components to house a larger cartridge if more area is needed. (d) they are more expensive to manufacture due to larger exterior components if more area is needed. (e) they are more expensive to manufacture due to larger cartridge if more area is needed. Also, cold and hot water inlet area at mounting surface of cartridge is often greater than inlet area of the movable control surface. Control surface refers to where a movable control disk and a fixed control disk form a seal plane for mixing.

Alternate cartridge designs that allow for increased area from hot and cold inlets do not maintain a seal beyond a perimeter of a movable disk. Such a problem can be particularly of concern when a control insert valve is employed like that described in U.S. Pat. No. 4,617,965 by Werner Lorch, when a fluid stream is not contained within the perimeter of a movable disk. More specifically, the U.S. Pat. No. 4,617,965 refers to a cartridge e.g. control insert with a condition where all inlet fluid streams do not pass through openings in the movable control surface. Since the fluid crosses a control surface boundary rather than pass through a movable control surface, fluid beyond the perimeter of a movable disk requires a sealed cartridge housing and additional seals to contain fluid inside such a cartridge. Also, use of such a cartridge for only one outlet use can result in stagnant water inside of the cartridge. Further, to use a cartridge with increased inlet area can require 4 inlet ports on the bottom of such a cartridge. Cartridge designs that allow for increased area have 2 inlet ports connecting to hot water and 2 inlet ports connecting to cold water at bottom of cartridge. Other cartridge designs claim optimal volume by enlarging the area of inlets in U.S. Pat. No. 5,857,489 by Chia-Bo Chang. Optimal volume cartridge described in U.S. Pat. No. 5,857,489 is a declared to be a step toward increased area for cartridges that employ a simple central mix chamber in or directly above control disks. Simple mixing chambers are bound by the underside of a movable control disk or simple mixing chambers are bound by the mixing plane in combination with the central area of a movable control disk in addition to a seal interfacing a drive part that provides an upper boundary. Smaller cartridges that have simple mixing chambers are numerous and common in most faucets yet they all seem to share inlet area limitations at the seal plane.

There are temperature controlled mixer valves like the one in U.S. Pat. No. 6,676,025 by Gerhard Ginter, where a fluid cartridge employs a temperature regulating unit. Such cartridges are not well suited for applications where a smaller cartridge is desirable.

3. Objects and Advantages

Accordingly, several objects and advantages of the present invention are:
(a) to provide a cartridge with a larger area for hot and cold water to enter a mixing chamber;
(b) to provide a cartridge with outer walls or peripheral components that do not contain fluid.
(c) to provide a smaller cartridge in new applications that require larger existing cartridges based on desired flow area
(d) to provide smaller components of cartridges
(e) to provide smaller components housing cartridges
(f) to provide designers more freedom to make more appealing designs based on smaller possible shapes
(g) to provide a cartridge with increased area for hot and cold inlet at control surface without necessarily requiring 2 input ports for hot water and 2 input ports for cold water at cartridge base
(h) to provide a replacement cartridge for existing faucets that currently have inadequate flow area
   Further objects and advantages are to provide a compact cartridge that may be suitable for applications that require more area than similar sized cartridges that are currently available. Still further objects and advantages will become apparent from a consideration of the ensuing description and drawings.

### SUMMARY

The invention provides increased inlet area at a control surface to facilitate the efficient mixing of hot and cold water. The inlet area at the control surface of this cartridge compares to much larger cartridges. The invention can be utilized in current applications that have inadequate inlet area at a given size requirement. Shower and bath applications where larger flow areas are common may also benefit from such an invention. dr

### DRAWINGS—FIGURES

The invention is described in greater detail hereinafter relative to non-limitative embodiments and the attached drawings, wherein:

FIG. 1 is a cross-section through part of a mixer valve with a control insert according to the invention.

FIG. 2 is a cross-section from a direction turned 90° relative to FIG. 1 with the control rod rotated respectively.

FIG. 3 is a top view of the moveable control disk of the arrangement according to FIG. 1

FIG. 4 is a bottom view of the moveable control disk of the arrangement according to FIG. 1

FIG. 5 is a cross-section through the arrangement according to FIG. 4

FIG. 6 is a top view of the fixed control disk of the arrangement according to FIG. 1

FIG. 7 is a bottom view of the fixed control disk of the arrangement according to FIG. 1

FIG. 8 is a cross-section through the arrangement according to FIG. 7

FIG. 9 is a cross-section through the arrangement according to FIG. 7

FIGS. 10 to 14 are diagrammatically positions of fixed and movable control disks.

FIGS. 15 and 16 are exploded views of the valve of FIG. 1.

### DRAWINGS—REFERENCE NUMERALS

20 cartridge

21 cartridge housing

22 movable control disk

23 bearing surface

24 fixed control disk

25 flange

26 valve seat

27 bearing surface

28 cavity

30 rotative control rod device

32 cover seat

34 attachment

36 cavity

38 motion transmission element

40 o-ring

42 protrusion feature

44 inlet cavity

46 inlet cavity

48 eccentric shaped cavity

50 mixing chamber

51 surface

52 hot water inlet

53 seal

54 hot water inlet

56 cold water inlet

58 cold water inlet

59 upper limit surface

60 seal slot

61 lower limit surface

62 seal

64 opening

66 opening

68 opening

69 outlet

70 protrusion

72 protrusion

74 outlet

76 side wall

78 side wall

79 channel

80 channel

81 protrusion

144 outlet

146 outlet

145 inlet

147 inlet

148 inlet

149 inlet

174 inlet

### DETAILED DESCRIPTION—PREFERRED EMBODIMENT

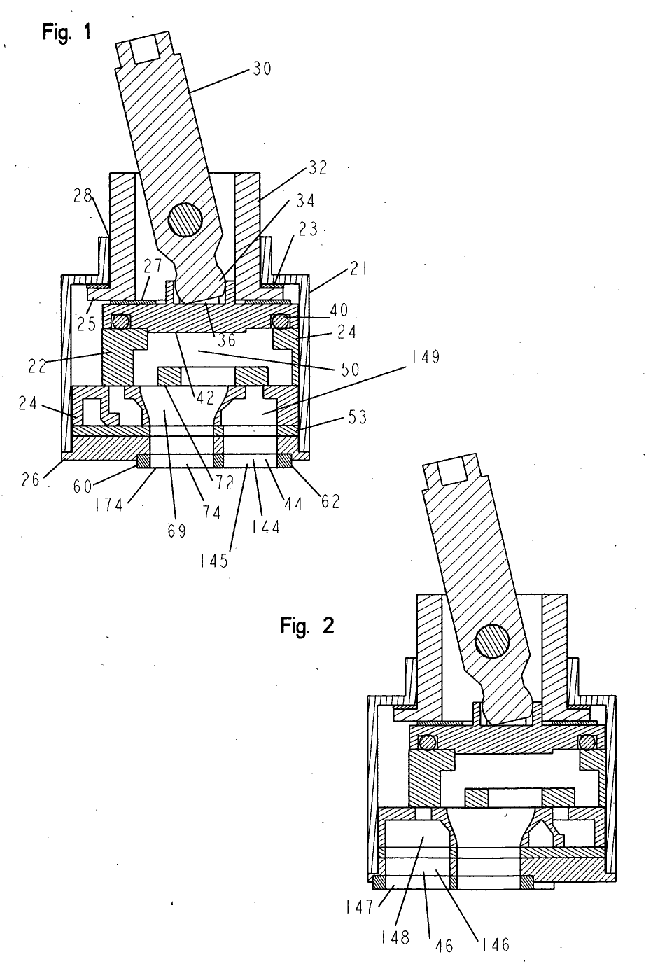

Referring to the attached drawings FIG. 1 and FIG. 2, the present invention generally includes a cartridge 20, a movable control disk 22, a fixed control disk 24, and a valve seat 26. A bearing surface 23 is located above a flange 25. A cartridge housing 21 is cylindrical, on the top, there is a cavity 28 of a smaller diameter. A rotative control rod device 30 is inserted in the cavity 28. The control rod 30 swings through the central axis of a cover seat 32, and includes an attachment 34. The control rod 30 extends down and continuous in an attachment 34 from a cover seat 32. The attachment 34 is placed in a corresponding cavity 36. The cavity 36 is located in an upper portion of a motion transmission element 38. A bearing surface 27 is located above transmission element 38. The transmission element 38 provides a range of motion for the control rod 30. An, O-ring 40 is beneath the transmission element 38 where said O-ring 40 seals transmission element 38 with the movable control disk 22. The transmission element 38 is equipped with a protrusion feature 42 extending downward into control disk 22. There are also two inlet cavities 44 and 46.

Referring to the FIGS. 1, 3, 4 and 5, the moveable disk 22 is a smaller diameter than the aforesaid cartridge 20. There is an eccentric shaped cavity 48 in the upper surface of the movable disk 22. The cavity 48 corresponds with a similar shaped protrusion feature 42 on the underside of the transmission element 38. The transmission element 38 is able to be inserted into the moveable disk 22 and to be mounted in the cartridge 20 while moving freely relative to the fixed disk 24. Also, there is a mixing chamber 50 in the movable disk 22. The mixing chamber 50 is connected to openings 64,66 and 68 in the movable control disk.

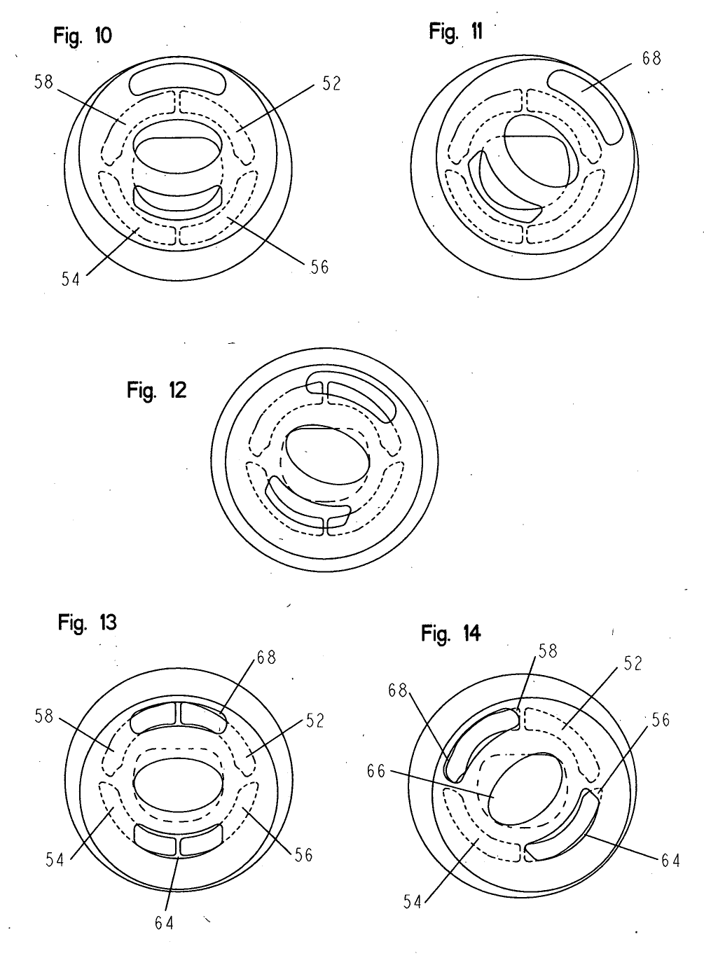

A valve seat 26 inserts and engages at bottom of the cartridge 20 and positions a seal 53 and the fixed disk 24 in the cartridge. The moveable disk 22 is subjected to the movement of the control rod 30 and is able to move and overlap the fixed disk 24. The control rod 30 drives the moveable disk 22 and alters various positions of the moveable disk 22 in relation to the fixed disk 24 (see FIGS. 10 to 14). The movable control disk has a lower limit surface which forms the movable control surface 61. To provide for outlet 74 water flow, the movable control disk openings 64 and 68 connect to both diametrically opposed hot water inlets 52 and 54 or both diametrically opposed cold water and inlets 56 and 58 or a combination of all diametrically opposed cold water and hot water inlets. All water exits the movable control disk by passing through outlet 69 of the fixed control disk 24. By way of the aforementioned connections, the movable control disk 22 is able to open or close or mix or deliver hot and cold water. Openings 64 and 68 connect to the mixing chamber 50. The mixing chamber 50 is able to open or close or mix or deliver hot and cold water to outlet 69.

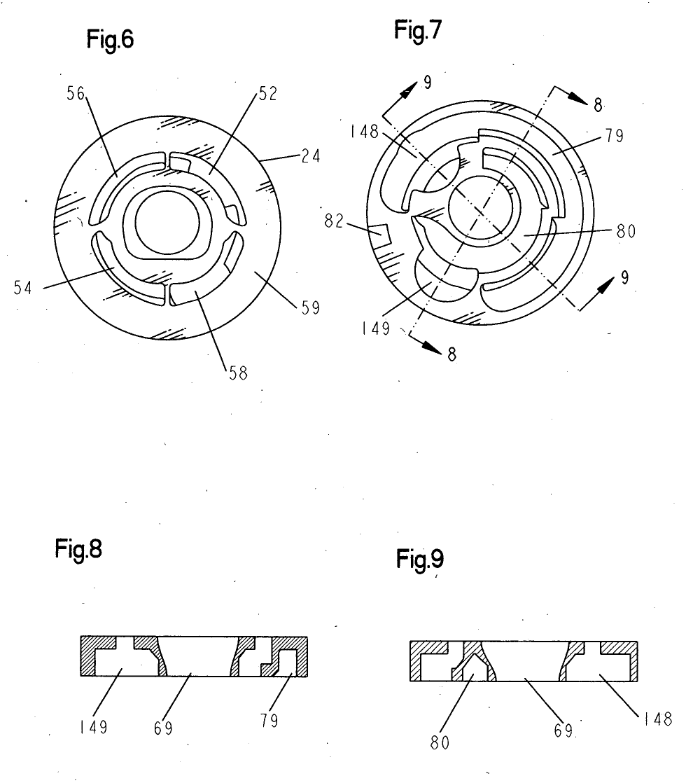

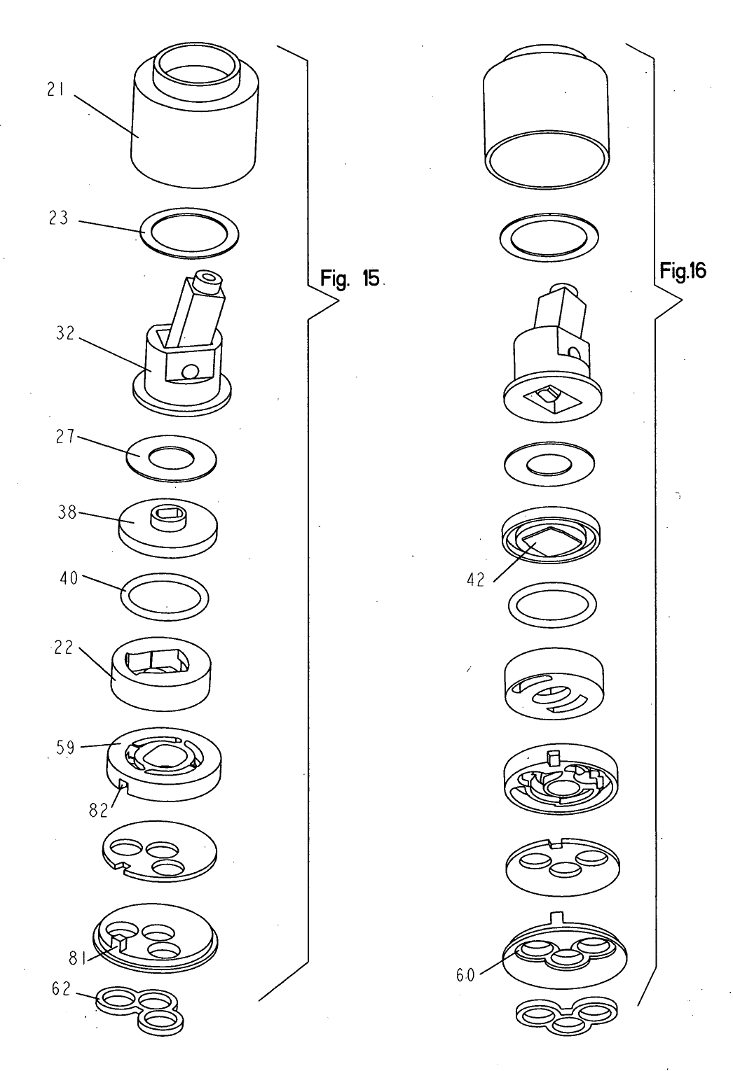

See FIGS. 1, 2, 6, 7 and 15. Below the movable control disk 22, the fixed control disk 24 is secured in the cartridge by void 82 and protrusion 81 in valve seat 26. The fixed control disk 24 has an upper limit surface 59 which forms the fixed control surface. The fixed control disk 24 has inlets 148,149 that receive flow from inlet cavities 46 and 44 respectively. The only diagrammatically represented fixed control disk 24 rest partly on the seal 53 and valve seat 26. In FIGS. 6 to 8, the fixed disk 24 contains channels 79,80 which have varying geometric cross sections suitable to accommodate desired flow area. In FIGS. 7 and 6, the channels 79 and 80 route the water flow to the diametrically opposed inlets 54 and 56. Channels 79 and 80 receive water flow originating from inlet cavities 46 and 44,

The valve seat 26 has A protrusion 81 which can secure the fixed disk 24, and limit~and balance compression of the fixed disk 24 with respect to seal 53 if assembled with a number of protrusions similar to protrusion 81 with accompanying notches as well. Seal 53 seals flow paths between the fixed control disk 24 and the valve seat 26.

In FIGS. 15, 16, 1 and 2, you can see a seal slot 60 in the valve seat and a seal 62 covers it to prevent the entire valve seat with the inlets 44 and 46 and the outlet 74 from leakage.

It is common practice to use a flat surface of two disks to form a seal plane by placing what we call control surfaces against each other to form a seal plain. In order to be clear, the term opening zone in a control surface means an opening in a control surface where an edge of said opening zone does not share an edge with a perimeter or boundary of said control surface.

With reference to FIG. 4, and FIGS. 10 to 14, the interactions of the two control disks for mixing the two water flows and for setting the water quantity will now be described. A rotation of the movable control disk 22 leads to a temperature change, whilst a displacement of the movable control disk in a direction of an alignment passing through the center of the 3 openings 64,66, and 68 permits the choice of the water quantity. In FIG. 14 the control disk is rotated counter clockwise to its end position and is simultaneously displaced to the right and downwards. The opening 68 of moveable control disk 22 completely frees the opening 58 of the fixed control disk 24, which is to be connected with the cold water. Simultaneously, the opening 64 of moveable control disk 22 completely frees opening 56, which is also connected to the cold water inlet. This position consequently means maximum opening at cold temperature. If the control disk 22 is now rotated clockwise, then the situation is as shown in FIG. 13. Opening 68 frees to an equal extent the openings 58,52 in the fixed control disk, whereas the opening 64 also to a roughly identical extent frees the openings 54 and 56.

Thus, FIG. 13 shows the control insert position with a 50% mixing ratio.

FIG. 12 shows the moveable control disk 22 rotated to some extent clockwise with respect to the position in FIG. 13 and is simultaneously displaced somewhat to the right, so that a somewhat hotter temperature with a somewhat lower flow rate is set.

If the moveable control disk 22 is moved upwards from the position in FIG. 13 without turning it, the position shown in FIG. 10 is obtained, in which the valve is closed in the central temperature position. In this closed position, control disk 22 can be rotated both clockwise and counterclockwise without the valve opening. In FIG. 11, the off position of the full hot orientation is displayed.

### Alternative Embodiments

There are applications where a compact cartridge that has dual simultaneous inlets in a movable control disk having a fixed control disk with at least 2 inlets for each water stream hot and cold, would be ideal when combined with a temperature regulator unit. Such a unit could be constructed using the inventions and simply adding a temperature regulating unit above the moveable control disk and isolating the two opening zones and isolating the outlet. Of course, the two water inlets 54 and 56 would originate from a same inlet at valve bottom. Also, inlets 58 and 52 would originate from the another different temperature inlet at the bottom of cartridge. The moveable control disk 22 could have protrusions 70 and 72 that be part of the same surface 51 and the three zones could each be separated by a seal as is done in other temperature regulator units. Such and assembly would have a higher flow area when the design is compared to compacted designs of the prior art.

With reference to FIGS. 1 to 5 and 14, there can be instances where a facility might want to maintain the temperature of the hot water a bit hotter than some people might feel is comfortable. Such facilities could use this invention where one of the dual hot water inlets 54 or 52 is not present in the fixed control disk 24. Therefore, the proportion of hot water to cold water could be changed and some people might find such conditions favorable. Similarly, this invention can also function as a cartridge that reduces the use of hot water. As noted in U.S. Pat. No. 6,845,917 by Mei-Li Chen a cartridge can be designed so as to reduce the use of hot water by changing the amount of inlet area overlapping with the control surfaces.

Also, there are certain applications where a facility might not keep the hot water at a high enough temperature for a majority of the patrons that use their rest rooms. These patrons could run the water excessively before the temperature is hot enough for their comfort. Such facilities could use this invention without one of the dual cold water outlets 56 or 58 in the fixed control disk 24 thereby reducing the waste of water and improving the response time in a mid position orientation of the cartridge handle.

The newly invented cartridge can also reduce inventory requirements by using the same fixed disk 24 in all assembled cartridges. In applications where higher flow is not desired, the movable control disk 22 can simply be fabricated without one of the two openings 64 or 68. Thus, a current typical cartridge performance may be achieved.

There are some applications where the invention can be used to mix and have two separate mixing outlets. It is very simple to divide the outlet chamber into two separate outlets. And, it would be easy to have two different mixing paths with different mixing rations due to different areas on the diametrically opposed inlet holes of the fixed control disk. Tub and bath applications could be an excellent use for the inventions.

The newly invented cartridge could easily have the translation or volume controlling throw positions divided into two index-able positions to allow for choosing typical cartridge flow or the newly improved cartridge flow.

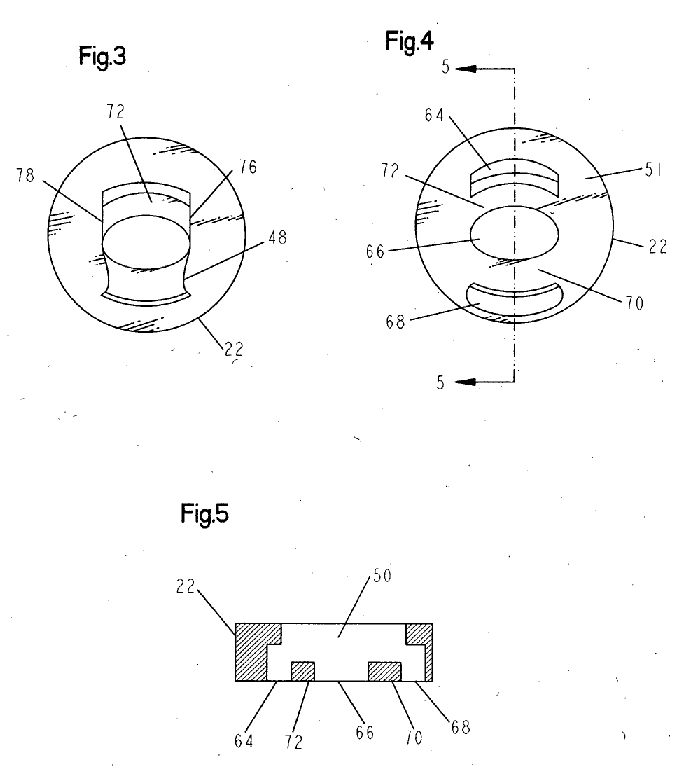

The movable control disk 22 in FIGS. 3, 4 and 5 has 3 openings 64,66 and 68 separated by a protrusion 70 and a protrusion 72, protrusion 72 extends to the side walls 76 and 78 of mixing chamber 50 in the control disk 22 of FIG. 3. The nonessential protrusion 72 as can be seen in FIG. 1, causes a stream of water to enter the mixing chamber 50 at a similar elevation as the opposing stream entering the control disk 22 for improved mixing. The protrusion 72 can also be used to divide the mixed stream where it bounds a diametrically opposed inlet over a divided outlet zone in a fixed control disk resulting in two separated mixed streams. By looking at FIG. 3 and 4, one can see that the removal of nonessential protrusion 72 effectively combines openings 64 and 66.

Also, the geometric features of the movable control disk 22 and fixed control disks 24 lend themselves to being fabricated out of ceramic, alumina etc. or even polymeric materials that may provide reasonable cost, life and performance. Furthermore, the movable and fixed control disks can be molded or formed by simple male and female molds without the need for slides or inserts.

The following lists some specific conditions for the valve cartridge referencing FIGS. 1, 2, 7, 8 and 9.

A cartridge 20 can be seated on a surface that allows for only one fluid inlet at 174 and then function with two fluid outlets 144,146.

Also the cartridge 20 can be seated on a surface that allows for two fluid inlets at 145,174 and one fluid outlet 146.

In addition, the cartridge 20 can be seated on a surface that allows for two fluid inlets at 147,174 and one fluid outlet 144.

Further, the cartridge 20 can be seated on a surface that allows for one fluid inlet at inlet cavity 44 and one fluid outlet 146.

Another alternate cartridge can have four separate fluid inlets and one or two outlets to function like similar 4 in port cartridges that have more components, are more complex, costly and therefore less desirable. However, this 4 in port would be one of the more simple 4 in port cartridge.

Also, the cartridge can be constructed using similar protrusion notches or pawls to secure the moveable control disk to the motion transmission element as is done in current cartridge designs.

Furthermore, the cartridge can be constructed using similar protrusion notches or pawls to secure and balance the fixed control disk to the valve seat as is done in current cartridge designs.

Additionally, the cartridge can be constructed using similar snap locking features that are currently used to secure the cartridge outer shell to the valve seat.

Similarly, the cartridge can be constructed similar to existing cartridges without requiring additional parts. From an appearance standpoint, the main differences distinguishing this invention from other cartridges are related to the geometry of the control disks and sealing.

When the invention is compared to equal size compact cartridges, the cost and complexity of cartridges are similar.

When the invention is compared to cartridges with equal overlapping control surface inlet areas, the cost of the newly invented cartridge and surrounding components can be substantially less.

The moveable control disk of this invention can be used to control the flow in other cartridge assemblies that do not have diametrically opposed inlets. Implementing such a design could reduce inventory of alternate parts for differing cartridges. Particularly, the movable control disk without the nonessential protrusion 72 might be a best case for standardizing use of the moveable control disk in cartridges that do not embody dual diametrically opposed inlets.

Also, the shapes of opening 64,66 and 68 in moveable control disk 22 can be modified so that unequal areas can be accommodated for reasons which effect flow rates, timing or flow proportions through the channels 78 and 80 of fixed control disk 24. Further, the shapes of inlets 52,54,56 and 58 in fixed control disk 24 can be modified for reasons that effect various flow rates or flow proportions through the channels 78 and 80 of fixed control disk 24. Including the elimination of one of the diametrically opposed fixed control disk inlets for each case hot and cold. Desired conditions can dictate the aforementioned geometry descriptions. For instance, sound, flow, quality or operation feedback needs may be manipulated by such changes.

Although the description above contains many specificities, these should not be construed as limiting the scope of the invention but as merely providing illustrations of some of the presently preferred embodiments of this invention.

Thus the scope of the invention should be determined by the appended claims and their legal equivalents, rather than by examples given.

### Advantages

The numerous advantages in the aforementioned items generally relate to flow area, size, cost and versatility. The newly invented cartridge can be used in many different applications where the smaller size is desired. Also, the cartridge can be used in applications where a cheaper alternative cartridge is desired. There may be numerous applications for which this cartridge may be preferred over the prior art.

I claim:

1. A sanitary mixer valve with a fixed control disk connectable to water inlet ports of the valve, the fixed control disk having at least one inlet for cold water and at least one inlet for hot water, a movable control surface having at least two opening zones mechanically coupled and movable with respect to a fixed control surface with two degrees of freedom, a mixer lever attached to the movable control surface for controlling quantity and mixing ration between opening zones as a function of position, wherein:
a movable control surface having an opening zone that can simultaneously overlap at least one inlet and at least one outlet in a fixed control surface as a function of position where said opening zone is in communication with a mixing chamber, said moveable control surface has a second opening zone connecting at least one separate fixed control surface inlet to said mixing chamber.

2. A valve according to claim 1, wherein two mixing flow paths lead to a common water outlet.

3. A valve according to claim 1, wherein the movable control surface has one opening zone movable across the fixed control surface inlet ports for controllably mixing water along one mixing flow path and a second opening zone mechanically coupled to the first opening zone and movable across the inlet ports for controlling a second mixing flow path.

4. A valve according to claim 1, wherein an opening zone in the moveable control surface is in communication with a separate opening zone in the moveable control surface, where communication at least partly occurs between the moveable control surface and a plane or sealed zone defined by a mechanically sealed opposing side of a movable control disk.

5. A valve according to claim 1, wherein the fixed control surface has in each case two opening zones for each opening zone in the movable control surface.

6. A valve according to claim 1, wherein a moveable control surface has an opening zone that is in communication with a separate opening zone in the moveable control surface, where communication at least partly occurs between the moveable control surface and a plane or sealing zone defined by a mechanically sealed opposing side of the movable control disk.

7. A valve according to claim 1, wherein two opening zones for each of the mixing flow paths diametrically face one another.

8. A valve according to claim 1, wherein the fixed control surface also has openings defining a path to a water outlet.

9. A valve according to claim 1, wherein the fixed and movable control surfaces are surfaces of planar control disks.

10. A sanitary mixer valve with a fixed control disk connectable to water inlet ports of the valve, the fixed control disk having at least one inlet for cold water and at least one inlet for hot water, a movable control surface having at least two opening zones mechanically coupled and movable with respect to a fixed control surface with two degrees of freedom, a mixer lever attached to the movable control surface for controlling quantity and mixing ration between opening zones as a function of position, wherein:
a movable control surface having an opening zone that can simultaneously overlap at least one inlet and at least one outlet in a fixed control surface as a function of position and said moveable control surface has a second opening zone connecting at least one separate additional fixed control surface inlet to an outlet in the fixed control surface wherein said moveable control surface inlets do not lead to a temperature regulating unit.

11. A valve according to claim 10, wherein the said moveable control surface has a second opening zone connecting at least one additional fixed control surface inlet to a second outlet in the fixed control surface.

12. A valve according to claim 10, wherein the movable control surface has a second opening zone that can overlap a separate additional inlet and at least one separate additional outlet in a fixed control surface as a function of position.

13. A sanitary mixer valve with a fixed control disk connectable to water inlet ports of the valve, the fixed control disk having at least one inlet for cold water and at least one inlet for hot water, a movable control surface having at least two opening zones mechanically coupled and movable with respect to a fixed control surface with two degrees of freedom, a mixer lever attached to the movable control surface for controlling quantity and mixing ration between opening zones as a function of position, wherein:
a movable control surface having an opening zone that can simultaneously overlap at least one inlet and at least one outlet in a fixed control surface as a function of position where said opening zone is in communication with a mixing chamber, said moveable control surface has a second opening zone connecting at least one separate fixed control surface inlet to an outlet in the fixed control surface
a movable control disk having a control surface on one side and two through holes emanating from 2 opening zones in the moveable control surface, at least one through hole functions as an inlet and at least one through hole functions as an outlet, both said through holes are contained by a mechanically sealed opposing side of the movable control disk.

14. A control insert for a sanitary mixer valve having means for connection to hot water and cold water supplies and having at least one outlet, the control insert comprising:
a fixed control surface which can be connected to water inlet ports of the valve, the fixed control surface having openings defining at least one opening zone for cold water and at least one opening zone for hot water from the supplies
a movable control surface having at least two opening zones cooperating with the fixed control surface with two degrees of freedom, and a mixer lever connected to the movable control surface for controlling quantity and mixing ratio as function of relative position of the fixed and movable control surface, movement of the control surfaces controlling alignment of openings in the movable control surface with at least one of the opening zones and the at least one water outlet, wherein at least two separable mechanically coupled flow paths are defined, the flow paths each having controllable connection to the hot water and cold water supplies.

15. A control insert according to claim 14, wherein the two mixing flow paths lead to a common water outlet.

16. A control insert according to claim 14, wherein the fixed control surface has in each case two opening zones for each opening zone in the movable control surface.

17. A control insert according to claim 14, wherein two opening zones for each of the mixing flow paths diametrically face one another.

18. A control insert according to claim 14, wherein the fixed control surface also has openings defining a path to a water outlet.

19. A control insert according to claim 14, wherein the fixed and movable control surfaces are surfaces of planar control disks.

20. A control insert according to claim 14, wherein a moveable control surface has an opening zone that is in communication with a separate opening zone in the moveable control surface, where communication at least partly occurs between the moveable control surface and a plane or a seal zone defined by a mechanically sealed opposing side of a movable control disk.

21. A control insert according to claim 14, wherein both mixing flow paths have at least partly corresponding control characteristics.

22. A control insert according to claim 14, wherein facing opening zones extend over roughly equal angles.

23. A control insert according to claim 14, wherein facing opening zones have cross sections of different areas.

24. A control insert according to claim 14, wherein a movable control surface having an opening zone that can simultaneously overlap at least one inlet and at least one outlet in a fixed control surface as a function of position where said opening zone is in communication with a mixing chamber, said moveable control surface has a second opening zone connecting at least one separate fixed control surface inlet to said mixing chamber.

25. A control insert according to claim 14, wherein the mixing flow paths have different flow characteristics.

26. A sanitary mixer valve with a fixed control surface connectable to water inlet ports of the valve, the fixed control surface having at least one opening zone for cold water and at least one opening zone for hot water, a control surface movable with respect to said fixed control surface with two degrees of freedom, a mixer lever attached to the movable control surface for controlling quantity and mixing ration between the opening zones and at least one out port as a function of position, wherein:
the fixed and movable control surfaces define at least two mechanically coupled controlled mixing flow paths and said movable control surface has at least 2 opening zones.

27. A control insert according to claim 26, wherein one of the 2 opening zones overlaps at least one inlet and part of the mixing outlet zone at control surface of fixed disk.

28. A control insert according to claim 26, capable of mixing two separate cold water streams that enter cartridge from one entry location at underside of valve seat.

29. A control insert according to claim 26, capable of mixing two separate hot water streams that enter cartridge from one entry location at underside of valve seat.

30. A control insert according to claim 26, wherein all fluid passing in through the control surface must pass back out through the control surface.

31. sanitary mixer valve with a fixed control surface connectable to water inlet ports of the valve, the fixed control surface having at least one opening zone for cold water and at least one opening zone for hot water, a control surface movable with respect to said fixed control surface with two degrees of freedom, a mixer lever attached to the movable control surface for controlling quantity and mixing ration between the opening zones and at least one out port as a function of position, wherein:
the valve is capable of mixing two separate cold water streams that enter valve from one entry location at underside of valve seat
the valve is capable of mixing two separate hot water streams that enter valve from one entry location at underside of valve seat.

32. sanitary mixer valve with a fixed control surface connectable to water inlet ports of the valve, the fixed control surface having at least one opening zone for cold water and at least one opening zone for hot water, a control surface movable with respect to said fixed control surface with two degrees of freedom, a mixer lever attached to the movable control surface for controlling quantity and mixing ration between the opening zones and at least one out port as a function of position, wherein:
the valve is capable feeding one cold water stream that enters valve from one entry location at underside of valve seat
the valve is capable of mixing two separate hot water streams that enter valve from one entry location at underside of valve seat.

33. sanitary mixer valve with a fixed control surface connectable to water inlet ports of the valve, the fixed control surface having at least one opening zone for cold water and at least one opening zone for hot water, a control surface movable with respect to said fixed control surface with two degrees of freedom, a mixer lever attached to the movable control surface for controlling quantity and mixing ration between the opening zones and at least one out port as a function of position, wherein:
the valve is capable feeding one hot water stream that enters valve from one entry location at underside of valve seat
the valve is capable of mixing two separate cold water streams that enter valve from one entry location at underside of valve seat.
